(19) United States
(12) Patent Application Publication
(10) Pub. No.: US 2020/0050722 A1
(43) Pub. Date: Feb. 13, 2020

(54) HYBRID MESHING METHOD FOR FINITE ELEMENT ANALYSIS

(71) Applicant: OnScale, Inc., Redwood City, CA (US)

(72) Inventors: Scott McClennan, Sunnyvale, CA (US); Gerald Harvey, San Francisco, CA (US); Laura Carcione, Los Altos, CA (US); Heike Broichhausen, Glasgow (GB); Ryan Diestelhorst, Atlanta, GA (US)

(21) Appl. No.: 16/536,463

(22) Filed: Aug. 9, 2019

Related U.S. Application Data
(60) Provisional application No. 62/717,226, filed on Aug. 10, 2018.

(51) Int. Cl. G06F 17/50; G06T 17/20

(52) U.S. Cl. CPC G06F 17/5018; G06F 2217/16; G06T 17/20

(57) ABSTRACT

Described here is a method for combining unstructured meshes of arbitrarily-ordered elements with regular structured grids to allow for the discretization of complex models for finite element analysis. The method maintains the computational efficiencies of grids for spatial domains within the model where meshes are not desirable or required by utilizing a hybrid discretization approach.

### CROSS-REFERENCE TO RELATED APPLICATIONS

This application claims the benefit of U.S. provisional patent application No. 62/717,226, filed on Aug. 10, 2018, and entitled “Hybrid Meshing Method,” the disclosure of which is expressly incorporated herein by reference in its entirety.

### TECHNICAL FIELD

The present disclosure relates to discretized meshing techniques for finite element mechanical, thermomechanical, and/or electromechanical analysis.

### BACKGROUND

Most commercial numerical modeling software packages use unstructured meshes of arbitrarily-ordered elements to discretize the spatial model domain for finite element or finite volume analysis. The primary benefit of unstructured meshes is that they are relatively easy to create to conform to complex geometries using well-established tessellation methods like Delaunay triangulation. Alternatively, structured grids provide significant advantages over unstructured meshes with respect to memory efficiency and computation time. However, structured grids can be difficult to conform to curved material boundaries in complex designs.

### SUMMARY

The present disclosure pertains to a method for combining unstructured meshes of arbitrarily-ordered elements with regular structured grids to allow for the discretization of complex models for finite element analysis. The method maintains the computational efficiencies of structured grids for homogeneous spatial domains within the model, while maintaining accuracy at complex material interfaces by utilizing an unstructured mesh only in the vicinity of material boundaries. This is achieved by creating a Cartesian grid that contains the model geometry, identifying regions with complex material interfaces, and replacing the space within those regions with an unstructured mesh. The boundary nodes of the remaining grid elements are used to seed the unstructured mesh generation in the voided region such that continuous mesh interfaces result, minimizing error at the interfaces during finite element analysis while reducing memory requirements and computation time for the homogenous regions of the model where structured grids are ideal.

An example computer-implemented method for creating a hybrid mesh of a three-dimensional (3D) model is described herein. The method can include applying a structured grid throughout an entirety of the 3D model, where the structured grid can include a plurality of elements. The method can also include identifying a complex material interface of the 3D model; removing one or more of the elements of the structured grid that intersect the complex material interface to form a voided region; and applying an unstructured mesh throughout the voided region. The unstructured mesh can approximate the complex material interface, and the unstructured mesh can be connected to the structured grid on both sides of the complex material interface.

In some implementations, the method can further include removing one or more of the elements of the structured grid within a defined distance of the complex material interface. Optionally, the method can further include identifying respective locations of vertices of the elements of the structured grid that bound the voided region.

Alternatively or additionally, the complex material interface can include at least one of a curve or an acute angle.

Alternatively or additionally, the unstructured mesh can include a plurality of 3D polyhedral elements. For example, the 3D polyhedral elements can be pyramids, hexahedrons, tetrahedrons, or combinations thereof.

Alternatively or additionally, the structured grid can be a Cartesian-structured grid.

Alternatively or additionally, the hybrid mesh of the 3D model can include the structured grid and the unstructured mesh.

In some implementations, the method can further include performing finite element analysis (FEA) using the hybrid mesh of the 3D model.

An example system for creating a hybrid mesh of a three-dimensional (3D) model is also described herein. The system can include a processor, and a memory operably connected to the processor, where the memory has computer-executable instructions stored thereon that, when executed by the processor, cause the processor to apply a structured grid throughout an entirety of the 3D model, where the structured grid can include a plurality of elements. The processor can also be configured to identify a complex material interface of the 3D model; remove one or more of the elements of the structured grid that intersect the complex material interface to form a voided region; and apply an unstructured mesh throughout the voided region. The unstructured mesh can approximate the complex material interface, and the unstructured mesh can be connected to the structured grid on both sides of the complex material interface.

An example computer-implemented method for creating a hybrid mesh of a two-dimensional (2D) model is described herein. The method can include applying a structured grid throughout an entirety of the 2D model, where the structured grid can include a plurality of elements. The method can also include identifying a complex material interface of the 2D model; removing one or more of the elements of the structured grid that intersect the complex material interface to form a voided region; and applying an unstructured mesh throughout the voided region. The unstructured mesh can approximate the complex material interface, and the unstructured mesh can be connected to the structured grid on both sides of the complex material interface.

In some implementations, the method can further include removing one or more of the elements of the structured grid within a defined distance of the complex material interface. Optionally, the method can further include identifying respective locations of vertices of the elements of the structured grid that bound the voided region.

Alternatively or additionally, the complex material interface can include at least one of a curve or an acute angle.

Alternatively or additionally, the unstructured mesh can include a plurality of 2D polygonal elements. For example, the 2D polygonal elements can be triangles, quadrilaterals, or combinations thereof.

Alternatively or additionally, the structured grid can be a Cartesian-structured grid.

Alternatively or additionally, the hybrid mesh of the 2D model can include the structured grid and the unstructured mesh.

In some implementations, the method can further include performing finite element analysis (FEA) using the hybrid mesh of the 2D model.

An example system for creating a hybrid mesh of a two-dimensional (2D) model is also described herein. The system can include a processor, and a memory operably connected to the processor, where the memory has computer-executable instructions stored thereon that, when executed by the processor, cause the processor to apply a structured grid throughout an entirety of the 2D model, where the structured grid can include a plurality of elements. The processor can also be configured to identify a complex material interface of the 2D model; remove one or more of the elements of the structured grid that intersect the complex material interface to form a voided region; and apply an unstructured mesh throughout the voided region. The unstructured mesh can approximate the complex material interface, and the unstructured mesh can be connected to the structured grid on both sides of the complex material interface.

It should be understood that the above-described subject matter may also be implemented as a computer-controlled apparatus, a computer process, a computing system, or an article of manufacture, such as a computer-readable storage medium.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE FIGURES

The components in the drawings are not necessarily to scale relative to each other. Like reference numerals designate corresponding parts throughout the several views. These and other features of will become more apparent in the detailed description in which reference is made to the appended drawings wherein:

FIG. 1 is a comparison between models of a sphere utilizing a structured voxel grid and an unstructured tetrahedral mesh.

FIG. 2 illustrates a two-dimensional (2D) circular model embedded within a background medium partitioned into a structured quadrilateral grid.

FIG. 3 illustrates the 2D circular model embedded within a background medium partitioned into a structured quadrilateral grid with regions near the material interface removed.

FIG. 4 illustrates the 2D circular model embedded within a background medium meshed using a combination of structured quadrilaterals and unstructured triangles.

FIG. 5 is an example computing device.

### DETAILED DESCRIPTION

The present disclosure can be understood more readily by reference to the following detailed description, examples, drawings, and their previous and following description. However, before the present devices, systems, and/or methods are disclosed and described, it is to be understood that this disclosure is not limited to the specific devices, systems, and/or methods disclosed unless otherwise specified, and, as such, can, of course, vary. It is also to be understood that the terminology used herein is for the purpose of describing particular aspects only and is not intended to be limiting.

The following description is provided as an enabling teaching. To this end, those skilled in the relevant art will recognize and appreciate that many changes can be made, while still obtaining beneficial results. It will also be apparent that some of the desired benefits can be obtained by selecting some of the features without utilizing other features. Accordingly, those who work in the art will recognize that many modifications and adaptations may be possible and can even be desirable in certain circumstances, and are contemplated by this disclosure. Thus, the following description is provided as illustrative of the principles and not in limitation thereof.

As used throughout, the singular forms “a,” “an” and “the” include plural referents unless the context clearly dictates otherwise. Thus, for example, reference to “a 3D model” can include two or more such 3D models unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

The present disclosure relates to a method for the discretization of models for finite element analysis (FEA). FEA is a mathematical tool for solving boundary value problems (BVP). A BVP is a system of differential equations with solution and derivative values specified at more than one point, for example, at the boundary of a model. According to FEA, a model (e.g., a 2D or 3D model as described herein) is broken into a finite number of small pieces (e.g., elements). This is sometimes referred to as “discretization” or “meshing.” Each individual element is represented by a set of element equations, where a set is one or more equations. The set of element equations for each individual element locally approximates the partial differential equations being analyzed. The respective sets of element equations for the individual elements are linked using compatibility or continuity equations to create a matrix. Boundary conditions are then applied, and the matrix is solved. FEA is known in the art and is therefore not described in further detail herein. It should be understood that FEA is used to solve BVPs in applications including, but not limited to, mechanical (e.g., stress), thermal (e.g., heat transfer), fluid flow, and electromagnetic.

Although the example methods are described for mechanical FEA applications, it should be understood that the methods described herein are applicable to other types of simulation models including, but not limited to, electromechanical, electromagnetic, thermal, and computational fluid dynamic (CFD), as well as other numerical techniques such as the finite volume method (FVM). As used herein, the term “structured grid” describes an ordered continuum of elements (e.g., voxels) that can be referenced by index in each spatial dimension. Similarly, the term “Cartesian-structured grid” describes a structured grid in which the elements are not arbitrarily-shaped such as cubes (for 3D models) or rectangles (for 2D models). This disclosure contemplates that the elements are not limited to regular hexahedrons (cubes) or rectangles can be other geometric objects or shapes. Furthermore, the term “unstructured mesh”, or simply “mesh,” describes an unordered collection of polyhedral elements (for 3D models) or polygonal elements (for 2D models).

It is understood by those skilled in the art that structured grids provide several advantages over meshes, including regular element shapes/sizes that are ideal for explicit integration, reducing memory requirements and increasing overall speed of computation. These advantages are especially important for models in which the element size is a very small fraction of the total model size, such as any model with high frequency waves traveling over (relatively) long distances. For these types of problems, which are generally limited to small mechanical deformation, implicitly defined nodal coordinates reduce the amount of data that needs to be stored per node and ordered structuring allows for extremely efficient looping and vectorization in the solver. These advantages expand the addressable design space by enabling the investigation of physical dimensions that would otherwise be impossible within the constraints of a finite set of computing resources.

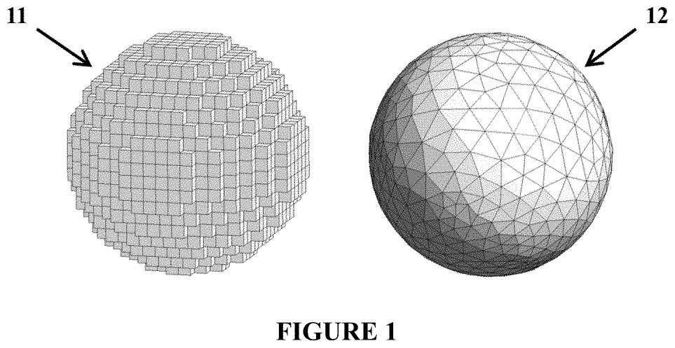

Structured grids do have drawbacks—namely, they are more difficult to conform to complex material boundaries (e.g., boundaries having curvature or acute angles) and to adapt spatially. This prevents them from being used effectively for mesh refinement in areas where there is specific interest without creating high aspect ratio or disconnected elements. Unstructured meshes are uniquely suited to address these issues. They are relatively easy to conform to complex geometries using well-established tessellation methods such as Delaunay triangulation (also known as Delone triangulation). FIG. 1 shows two meshed versions of a simple sphere. On the left, the sphere is meshed using only a structured voxel grid 11. This yields jagged surfaces that can affect the accuracy of the numerical simulation. On the right, the sphere is meshed using unstructured tetrahedrons 12, which provide a much smoother surface and can reduce error during analysis. In addition, because unstructured meshes (e.g., unstructured tetrahedrons 12) do not rely on being well-ordered in space, they are able to be refined to high density in areas where reduced discretization error is desirable. The methods described herein combine these meshing techniques (i.e., combining structured grid and unstructured mesh) into a hybrid approach that can leverage the advantages of each, where appropriate, without a significant impact from each technique's limitations.

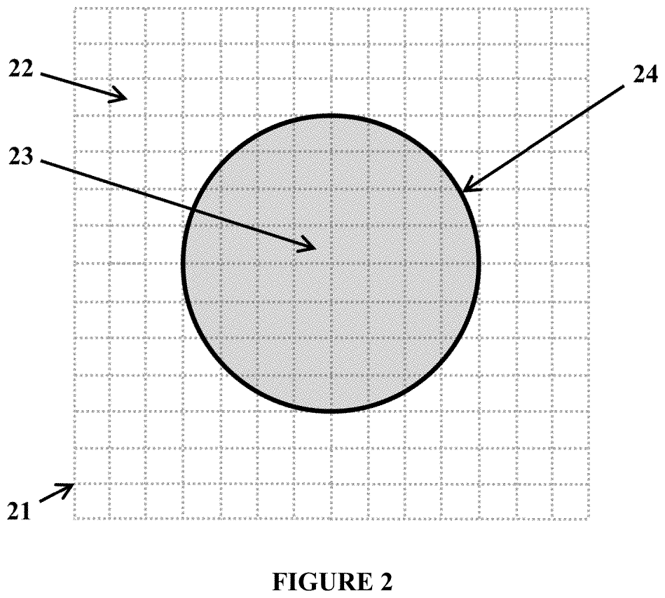

For the purposes of describing the method, terminology specific to three-dimensional (3D) model geometries is used, however it should be understood by those skilled in the art that the method is applicable to 2D models by altering the types of mesh elements (e.g., rectangles instead of voxels or polygons instead of polyhedrons). For clarity, FIGS. 2-4 are presented in 2D. The method begins by applying a Cartesian voxel grid 21 to the entire model, which is a solid sphere 23 in FIG. 2. It should be understood that the solid sphere 23 shown in FIG. 2 is provided only as an example model. The voxel grid 21 is applied in the regions where unstructured meshing is ultimately desired. In this example, shown in FIG. 2, the voxel grid 21 comprises a plurality of cubic volumes 22, which are also shown by the dotted lines in FIG. 2, that contains the solid sphere 23, where the cubic volumes 22 and the sphere 23 are assumed to be distinct homogenous materials that are well-suited for FEA using a structured grid. This disclosure contemplates that the density of the voxel grid 21 (e.g., the size of the cubic volumes 22) can be determined by the user (e.g., selected by user) or determined automatically. When automatically determined, this disclosure contemplates that the size of the model, the size of its constituent elements, and/or the frequency of the simulation inputs to that model can be considered. Higher voxel density can produce more accurate results but requires more computing resources (e.g., processing power, computation time, and/or memory). By contrast, the material interface 24 (also referred to herein as “complex material interface”) at the surface of the sphere 23 cannot be well-approximated by a structured grid of this density. As described herein, a complex material interface is any surface of the model to which it is difficult to conform elements of the structured grid. For example, the complex material interface can include curvature or an acute angle. When such complex material interface is meshed with a structured grid, it may yield jagged surfaces (e.g., see FIG. 1), which can affect the accuracy of the numerical simulation. In FIG. 2, the geometry of the material interface 24 is complex because it includes curvature, and it is therefore difficult to create a structured grid (e.g., voxel grid 21) that conforms to its geometry. To model the material interface 24 of FIG. 2 properly using a structured grid, the density of the voxel grid 21 (e.g., size of the cubic volumes 22) would need to be reduced significantly as compared to the density shown in FIG. 2, increasing the memory requirements and computation time for the entire model. This is often an undesirable tradeoff. It should be understood that the material interface 24 shown in FIGS. 2-4 is a single, continuous interface. It should also be understood that the model (e.g., 2D or 3D model) can include more than one material interface having complex geometry, and such material interfaces need not be continuous.

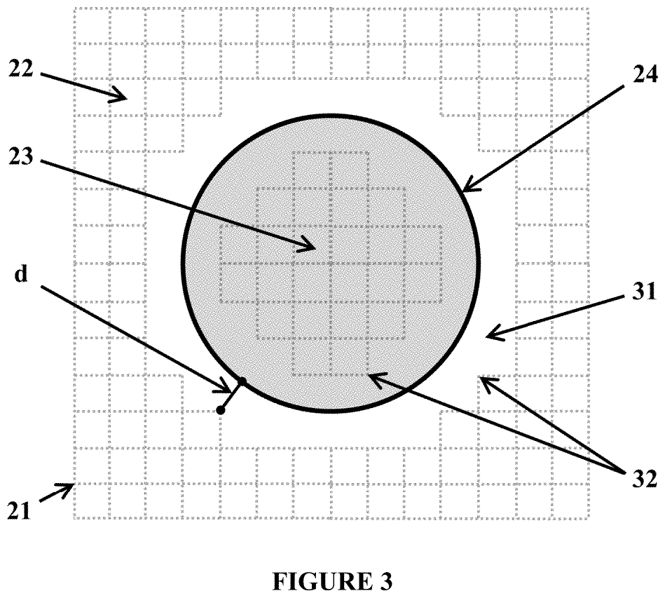

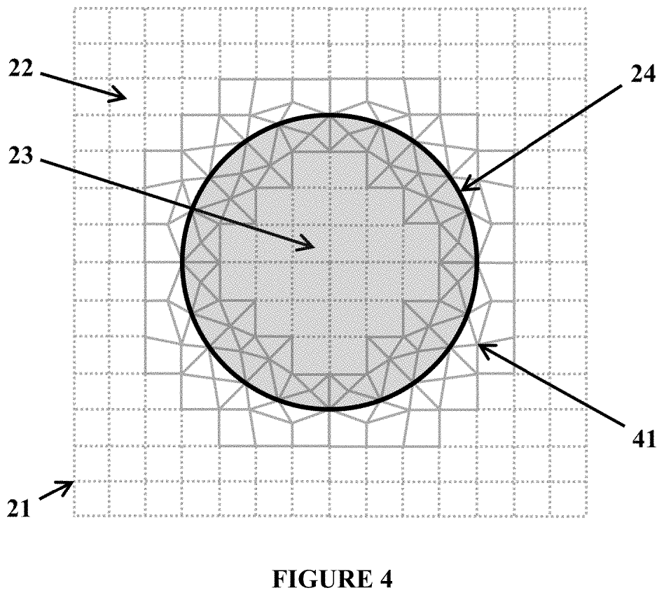

Referring now to FIG. 3, the method includes removing one or more of the cubic volumes 22 that intersect or are adjacent to the material interface 24. In some implementations, one or more cubic volumes 22 that contain the material interface 24 are removed. In other words, the cubic volumes 22 with which the material interface 24 intersects are removed. Alternatively or additionally, one or more cubic volumes 22 within a defined distance “d” from the material interface 24 are optionally removed. In other words, the cubic volumes 22 adjacent to the material interface 24 are removed. As a result, the entire material interface 24 is located within the voided region 31 in the voxel grid 21. The distance “d” is selected to ensure there is enough space for mesh generation in the voided region 31, and thus the proper transition of forces, fluids, heat, fields, etc. through the material interface 24 during FEA. Following the removal of these elements, the locations of the vertices 32 of the exposed faces of the remaining cubic volumes 22 that bound the voided region 31 are used to generate connectivity and coordinate arrays. Each coordinate represents a vertex 32 that is at least distance “d” from the material interface 24. If “d” is chosen to be too small, the vertices at the inner and outer boundaries of the voided region 31 will be close together and will force a small element size when the unstructured mesh (e.g., unstructured mesh 41 in FIG. 4) is generated, increasing solution complexity. Conversely, a choice of “d” that is too large will create an unnecessarily large unstructured mesh region and reduce the benefit of the structured grid.

Subsequently, the method includes applying an unstructured mesh throughout the voided region. As depicted in FIG. 4, the vertices 32 as well as a surface representing the material interface 24 are used to seed an unstructured mesh 41 to fill the voided region 31. This disclosure contemplates that tessellation methods such as Delaunay triangulation (also known as Delone triangulation) can be used to create the unstructured mesh 41 in the voided region 31. Delaunay triangulation is an example tessellation method known in the art. For example, Delaunay triangulation is described in Shewchuk, J. R., “Lecture Notes on Delaunay Mesh Generation,” available at https://people.eecs.berkeley.edu/Hrs/meshpapers/delnotes.pdf (2012). It should be understood that Delaunay triangulation is provided only as an example and that other tessellation methods can be used to create the unstructured mesh 41. In this example, shown in FIG. 4, the unstructured mesh 41 comprises hexahedrons and tetrahedrons (quadrilaterals and triangles in the 2D figures), however it is understood that other meshing elements may be used to ensure interelement compatibility. For example, pyramids may be used as an interface between the voxel elements and the tetrahedrons, as they are not strictly compatible. As shown in FIG. 4, a hybrid mesh, which includes both the voxel grid 21 and the unstructured mesh 41, is created. Optionally, the method includes performing FEA using the hybrid mesh of the resulting model. As described above, FEA includes representing each individual element of the hybrid mesh by a set of element equations. The set of element equations for each individual element locally approximates the partial differential equations being analyzed. The respective sets of element equations for the individual elements are linked using compatibility or continuity equations to create a matrix. Boundary conditions are then applied, and the matrix is solved.

The resulting model (i.e., the model with the hybrid mesh) represents a much better approximation of the contours of the sphere 23 which will improve the accuracy of FEA at the material interface 24. In addition, the homogenous regions of the design, both internal and external to the sphere 23, will benefit from the use of a structured grid by requiring less memory and computation time. The method described herein is designed to accelerate explicit time-domain FEA of complex structures using mechanical, electromechanical, electromagnetic, and thermal physics. Specifically, it is designed to be used with an FEA solver that can process and reference both structured and unstructured mesh data structures within the same simulation workflow. Despite this, it can be reasonably extended to other forms of FEA such as implicit and frequency-domain approaches without modifying the underlying principles.

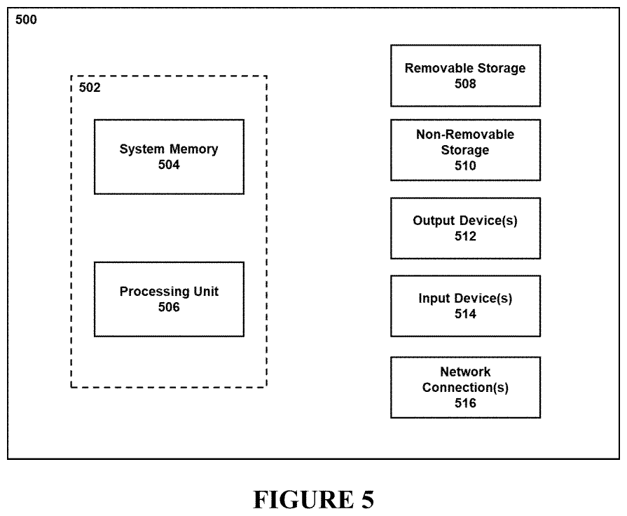

Referring to FIG. 5, an example computing device 500 upon which the methods described herein may be implemented is illustrated. It should be understood that the example computing device 500 is only one example of a suitable computing environment upon which the methods described herein may be implemented. Optionally, the computing device 500 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, computing device 500 typically includes at least one processing unit 506 and system memory 504. Depending on the exact configuration and type of computing device, system memory 504 may be volatile (such as random access memory (RAM)), non-volatile (such as read-only memory (ROM), flash memory, etc.), or some combination of the two. This most basic configuration is illustrated in FIG. 5 by dashed line 502. The processing unit 506 may be a standard programmable processor that performs arithmetic and logic operations necessary for operation of the computing device 500. The computing device 500 may also include a bus or other communication mechanism for communicating information among various components of the computing device 500.

Computing device 500 may have additional features/functionality. For example, computing device 500 may include additional storage such as removable storage 508 and non-removable storage 510 including, but not limited to, magnetic or optical disks or tapes. Computing device 500 may also contain network connection(s) 516 that allow the device to communicate with other devices. Computing device 500 may also have input device(s) 514 such as a keyboard, mouse, touch screen, etc. Output device(s) 512 such as a display, speakers, printer, etc. may also be included. The additional devices may be connected to the bus in order to facilitate communication of data among the components of the computing device 500. All these devices are well known in the art and need not be discussed at length here.

The processing unit 506 may be configured to execute program code encoded in tangible, computer-readable media. Tangible, computer-readable media refers to any media that is capable of providing data that causes the computing device 500 (i.e., a machine) to operate in a particular fashion. Various computer-readable media may be utilized to provide instructions to the processing unit 506 for execution. Example tangible, computer-readable media may include, but is not limited to, volatile media, non-volatile media, removable media and non-removable media implemented in any method or technology for storage of information such as computer readable instructions, data structures, program modules or other data. System memory 504, removable storage 508, and non-removable storage 510 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 506 may execute program code stored in the system memory 504. For example, the bus may carry data to the system memory 504, from which the processing unit 506 receives and executes instructions. The data received by the system memory 504 may optionally be stored on the removable storage 508 or the non-removable storage 510 before or after execution by the processing unit 506.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-implemented method for creating a hybrid mesh of a three-dimensional (3D) model, comprising:
applying a structured grid throughout an entirety of the 3D model, the structured grid comprising a plurality of elements;
identifying a complex material interface of the 3D model;
removing one or more of the elements of the structured grid that intersect the complex material interface to form a voided region;
applying an unstructured mesh throughout the voided region, wherein the unstructured mesh approximates the complex material interface, and wherein the unstructured mesh is connected to the structured grid on both sides of the complex material interface.

2. The computer-implemented method of claim 1, further comprising removing one or more of the elements of the structured grid within a defined distance of the complex material interface.

3. The computer-implemented method of claim 2, further comprising identifying respective locations of vertices of the elements of the structured grid that bound the voided region.

4. The computer-implemented method of claim 1, wherein the complex material interface includes at least one of a curve or an acute angle.

5. The computer-implemented method of claim 1, wherein the unstructured mesh comprises a plurality of 3D polyhedral elements.

6. The computer-implemented method of claim 5, wherein the 3D polyhedral elements are pyramids, hexahedrons, tetrahedrons, or combinations thereof.

7. The computer-implemented method of claim 1, wherein the structured grid is a Cartesian-structured grid.

8. The computer-implemented method of claim 1, wherein the hybrid mesh of the 3D model comprises the structured grid and the unstructured mesh.

9. The computer-implemented method of claim 8, further comprising performing finite element analysis (FEA) using the hybrid mesh of the 3D model.

10. A system for creating a hybrid mesh of a three-dimensional (3D) model, comprising:
a processor; and
a memory operably connected to the processor, wherein the memory has computer-executable instructions stored thereon that, when executed by the processor, cause the processor to:
apply a structured grid throughout an entirety of the 3D model, the structured grid comprising a plurality of elements;
identify a complex material interface of the 3D model;
remove one or more of the elements of the structured grid that intersect the complex material interface to form a voided region;
apply an unstructured mesh throughout the voided region, wherein the unstructured mesh approximates the complex material interface, and wherein the unstructured mesh is connected to the structured grid on both sides of the complex material interface.

11. A computer-implemented method for creating a hybrid mesh of a two-dimensional (2D) model, comprising:
applying a structured grid throughout an entirety of the 2D model, the structured grid comprising a plurality of elements;
identifying a complex material interface of the 2D model;
removing one or more of the elements of the structured grid that intersect the complex material interface to form a voided region;
applying an unstructured mesh throughout the voided region, wherein the unstructured mesh approximates the complex material interface, and wherein the unstructured mesh is connected to the structured grid on both sides of the complex material interface.

12. The computer-implemented method of claim 11, further comprising removing one or more of the elements of the structured grid within a defined distance of the complex material interface.

13. The computer-implemented method of claim 12, further comprising identifying respective locations of vertices of the elements of the structured grid that bound the voided region.

14. The computer-implemented method of claim 11, wherein the complex material interface includes at least one of a curve or an acute angle.

15. The computer-implemented method of claim 11, wherein the unstructured mesh comprises a plurality of 2D polygonal elements.

16. The computer-implemented method of claim 15, wherein the 2D polygonal elements are triangles, quadrilaterals, or combinations thereof.

17. The computer-implemented method of claim 11, wherein the structured grid is a Cartesian-structured grid.

18. The computer-implemented method of claim 11, wherein the hybrid mesh of the 2D model comprises the structured grid and the unstructured mesh.

19. The computer-implemented method of claim 18, further comprising performing finite element analysis (FEA) using the hybrid mesh of the 2D model.

20. A system for creating a hybrid mesh of a two-dimensional (2D) model, comprising:
a processor; and
a memory operably connected to the processor, wherein the memory has computer-executable instructions stored thereon that, when executed by the processor, cause the processor to:
apply a structured grid throughout an entirety of the 2D model, the structured grid comprising a plurality of elements;
identify a complex material interface of the 2D model;
remove one or more of the elements of the structured grid that intersect the complex material interface to form a voided region;
apply an unstructured mesh throughout the voided region, wherein the unstructured mesh approximates the complex material interface, and wherein the unstructured mesh is connected to the structured grid on both sides of the complex material interface.
